(19) United States
(12) Patent Application Publication
(10) Pub. No.: US 2007/0078764 A1
(43) Pub. Date: Apr. 5, 2007

(54) Scalable lazy payment capture in online commerce systems

(75) Inventors: Carlos Antonio Lorenzo Hoyos, Morrisville, NC (US); Andrea Jean Watkins Moryadas, Brattleboro, VT (US); Marcelo Perazolo, Cary, NC (US); Mark E. Peters, Chapel Hill, NC (US); Viswanath Srikanth, Chapel Hill, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/243,088

(22) Filed: Oct. 4, 2005

(51) Int. Cl. G06Q 40/00

(52) U.S. Cl. 705/40

(57) ABSTRACT

Embodiments of the invention can include an online commerce system, method and computer program product configured for scalable lazy payment capture. The system can include an online commerce system configured for communicative coupling with a merchant account system and one or more customers over a data communications network. The system further can include scalable lazy payment capture logic coupled to the online commerce system. The scalable lazy payment capture logic can include program code enabled to selectively apply lazy payment capture to partial payments for authorized payment amounts for different customers using multiple different payment methods

### BACKGROUND OF THE INVENTION

1. Field of the Invention

The present invention relates to the field of online commerce and more particularly to payment capture in an online commerce system.

2. Description of the Related Art

In e-commerce systems prevalent today, credit card payments are processed rigidly where a specified charge first is submitted for approval at the financial institution of the customer and subsequently the approved charge amount is captured into an account at the financial institution of the merchant. Most credit card and charge card clearing agreements for merchant accounts require that payment captures do not occur until the purchased products or services are provided. In the context of a retail transaction for a purchased product, payment for an authorized charge amount is not to be captured until the product ships to the customer.

The basic payment authorization and capture process for credit card and debit charges has proven reliable for straightforward commerce situations where a single order is placed for a few items that are to be shipped to the same destination at the same time and so forth. As orders become more complex, however, it can be necessary to capture payments for charge amounts less than an approved amount. A typical circumstance can include where different portions of an order are shipped at different times.

To handle the foregoing circumstance, more sophisticated payment systems allow for payment captures to occur for amounts less than the authorized charge amount. In this way, the customer transaction retains its online characteristic even though mere portions of the authorized charge amount are captured at different times. Notwithstanding, partitioning an authorized charge amount across multiple, different payment capture transactions at different times can give rise to several undesirable challenges.

First, not all financial processors include technology able to handle the partitioning of an authorized charge amount across multiple payment captures. Second, when partitioning an authorized charge amount across multiple payment captures, the number of financial transactions required to complete the full payment capture can equal the sum of the individual payment captures and an additional transaction for the approval. Each payment transaction, however, can result in a separate charge to the merchant. Therefore, this method can increase the total cost per order for the merchant.

To avoid the excessive costs of multiple captures, merchants can batch process all captures at the end of the business day. To do so, however, defeats the online characteristic for the transaction. Addressing the excessive costs of multiple captures, U.S. Patent Application Publication No. 2002/0132662 to Sharp et al for Micro-Payment Method and System teaches a method performed in an interactive client server system of charging micro-payments to a third party billing server on behalf of a user using the interactive client server system.

The Sharp method is a lazy payment capture methodology that includes requesting and receiving billing authorization for a charge limit. On condition of a confirmed authorization for the charge limit, charge events having an associated charge in monetary terms are generated and the charge for the charge events is summed, but not captured. Only when the summed charges reach the limit, the charge summation are sent to a billing server to be debited from the account of the user as payment. Hence, all charges leading up to the limit are merely lazy captured and the actual capture of payment does not occur until the charge limit is reached.

Notwithstanding the teachings of Sharp, it is not always feasible to assume that multiple payments for an authorized charge are to be made using a single payment method. Moreover, it is not always desirable to apply lazy payment capture—particularly where cost and risk factors suggest the immediate capture of as much of an authorized charge as possible. Finally, on occasion, the trigger point for lazy payment capture is not reached in a timely manner allowing for the accumulated charges to remain uncaptured. Accordingly, it would be desirable to permit scalability in a lazy payment capture system and method.

### BRIEF SUMMARY OF THE INVENTION

Embodiments of the present invention address deficiencies of the art in respect to payment capturing in an online commerce system and provide a novel and non-obvious method, system and computer program product for scalable lazy payment capture in an online commerce system. In one embodiment of the invention, a computer implemented scalable lazy payment capture method can include receiving payment authorization for a payment amount from a merchant account system, detecting one or more payment capture requests for portions of the payment amount, consulting a set of established rules for applying lazy payment capture to portions of the payment amount, and deferring a request for payment capture for the payment amount from the merchant account system until enough of the payment capture requests have been received to account for the payment amount only when permitted by the established rules.

The established rules can specify the activation of lazy payment capture only where the payment amount does not exceed a threshold value. The lazy payment capture rules further can specify the activation of lazy payment capture only where the type of items or services ordered are not deemed to require an immediate capture of payment. The lazy payment capture rules yet further can specify the activation of lazy payment capture only where a customer is considered risk-worthy. Finally, the lazy payment capture rules can specify the activation of lazy payment capture only where the type of payment is considered risk-worthy such as direct deposit as opposed to a credit card transaction.

The step of detecting the payment capture requests for portions of the payment amount further can include, for each detected payment capture request, computing a sum of portions of the payment amount for which payment capture requests have been detected, and further computing a remaining portion of the payment amount not yet requested for capture. Also, the deferring step in which payment capture requests are deferred for the payment amount until enough payment capture requests have been recieved further can include forwarding a payment capture request for the payment amount to the merchant account system.

In one aspect of the embodiment, the step of deferring a request for payment capture for the payment amount from the merchant account system until enough of the payment capture requests have been received to account for the payment amount, can include deferring a request for payment capture for the payment amount from the merchant account system until the computed sum of the portions of the payment amount for which payment capture requests have been detected is equivalent to the payment amount.

Alternatively, the step of deferring a request for payment capture for the payment amount from the merchant account system until enough of the payment capture requests have been received to account for the payment amount, can include deferring a request for payment capture for the payment amount from the merchant account system until the computed remaining portion of the payment amount not yet requested for capture is equal to zero. Finally, the step of deferring a request for payment capture for the payment amount from the merchant account system until enough of the payment capture requests have been received to account for the payment amount, further can include requesting an immediate capture of the computed sum when a threshold period of time elapses without the computed sum equaling the payment amount.

In another embodiment of the invention, an online commerce system configured for lazy payment capture can include an online commerce system configured for communicative coupling with a merchant account system and one or more customers over a data communications network. The system further can include scalable lazy payment capture logic coupled to the online commerce system. The scalable lazy payment capture logic can include program code configured to selectively apply lazy payment capture to partial payments for authorized payment amounts for different customers using different payment methods.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an online commerce system configured for scalable lazy payment capture;

FIG. 2 is a class diagram of a scalable lazy payment capture architecture;

FIG. 3 is an event diagram illustrating a process for scalable lazy payment capture; and,

FIG. 4 is a flow chart illustrating a process for scalable lazy payment capture.

### DETAILED DESCRIPTION OF THE INVENTION

Embodiments of the present invention provide a method, system and computer program product for scalable lazy payment capture in an online commerce system. In accordance with an embodiment of the present invention, a merchant can establish a set of lazy payment capture rules indicating when to apply lazy payment capture and when to directly capture a charge. The rules can include avoiding lazy payment capture when an order amount does not exceed a threshold value, when a particular good or service has been ordered such as a rare and valuable good or service, when a customer has not proven to be risk worthy, and when a type of payment is considered to be of higher risk than other forms of payment. The merchant also can establish a rule which can terminate lazy payment capture for an order when a period of time has elapsed without reaching a threshold triggering a direct capture of an associated authorized charge amount.

Once the lazy payment capture rules have been established, a payment authorization can be obtained for a purchase amount for goods or services purchased through the online commerce system. Subsequently, the established lazy payment capture rules can be consulted and a lazy payment capture for only a portion of the purchase amount can be requested. Instead of completing the capture operation for the portion of the purchase amount, the capture operation can be deferred and the capture request can be recorded so as to indicate an amount remaining to be captured to achieve the full purchase amount. When a capture request can be received for a portion of the purchase amount so as to result in no amount remaining to be captured, a single capture operation for the entire purchase amount can be requested, irrespective of the payment method.

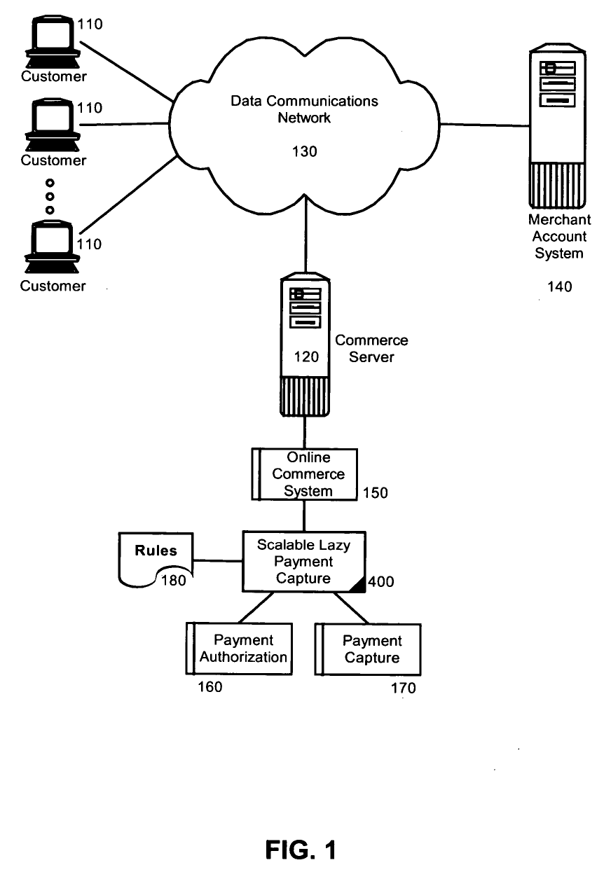

In further illustration, FIG. 1 is a schematic illustration of an online commerce system configured for scalable lazy payment capture. As shown in FIG. 1, an online commerce system configured for lazy payment capture can include a commerce server 120 configured for communicative coupling to one or more customer computing devices 110 over a data communications network 130. The commerce server 120 can include an online commerce system 150 enabled to process received purchase requests from the customer computing devices 110.

The online commerce system 150 can be coupled to both payment authorization logic 160 and payment capture logic 170. The payment authorization logic 160 can include program code enabled to request authorization for payment for a customer purchase from a merchant account system 140 over the data communications network 130. Likewise, the payment capture logic 170 can include program code enabled to request payment capture from the merchant account system 140 of a portion or all of a payment amount authorized by payment authorization logic 160.

Notably, scalable lazy payment capture logic 400 can be coupled to the online commerce system 150, a set of lazy payment capture rules 180, the payment authorization logic 160 and the payment capture logic 170. The scalable lazy payment capture logic 400 can include program code enabled to record an initially authorized payment amount and to defer a capturing of portions of the payment amount responsive to intermediate payment capture requests for only portions of the payment amount until the sum of all portions requested for capture equals the authorized payment amount. Only at that time can the scalable lazy payment capture logic 400 permit the requesting of a payment capture from the merchant account system 140 for the purchase amount, irrespective of the payment method for the purchase amount.

The deferral of capturing portions of the payment amount, however, can be contingent upon an evaluation of the lazy payment capture rules 180. Specifically, the lazy payment capture rules 180 can specify the activation of lazy payment capture only where the purchase amount does not exceed a threshold value. The lazy payment capture rules 180 further can specify the activation of lazy payment capture only where the type of items or services ordered are not deemed to require an immediate capture of payment. The lazy payment capture rules 180 yet further can specify the activation of lazy payment capture only where a customer is considered risk-worthy. Finally, the lazy payment capture rules 180 can specify the activation of lazy payment capture only where the type of payment is considered risk-worthy such as direct deposit as opposed to a credit card transaction.

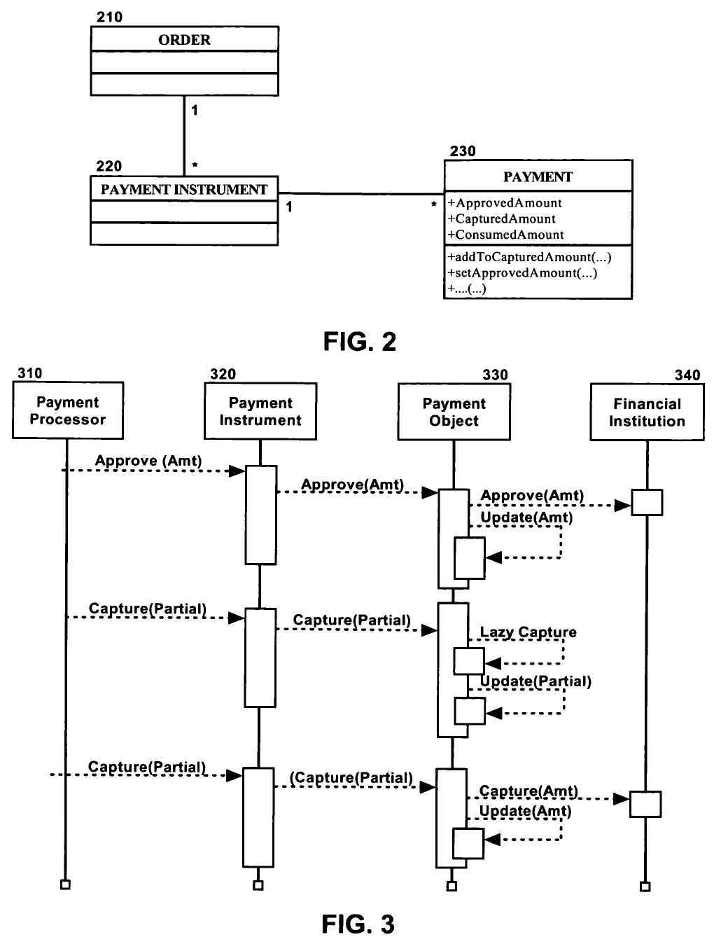

In one aspect of the invention, the scalable lazy payment capture logic 400 can include an object-oriented architecture. In further illustration, FIG. 2 is a class diagram of a scalable lazy payment capture architecture. The architecture can include an order instance 210 associated with one or more payment instrument instances 220. Each payment instrument instance 220, in turn, can be associated with one or more payment instance 230. Each payment instance 230 can include data members sufficient to store an authorized purchase amount, an amount captured, and an amount of the authorized purchase amount which has already been consumed as a result of one or more capture requests.

The payment instance 230 also can include several method members. A first method member can add a capture amount for a deferred capture for a portion of the authorized purchase amount, whenever a capture request is received for a portion of the authorized purchase amount. A second method member can establish the authorized purchase amount. Optionally, other methods can compute an already consumed amount of the authorized purchase amount so as to trigger a request to capture the purchase amount from a merchant account system.

In more particular illustration, FIG. 3 is an event diagram illustrating a process for scalable lazy payment capture. As shown in FIG. 3, a payment processor 310 can request the approval of a specified, purchase amount. The request can be received by the payment instrument 320 which can issue a request for approval of the amount to the payment object 330. The payment object 330, in turn, can request approval for the purchase amount from the financial institution 340. Subsequently, the payment object 330 can update its data members to set the authorized payment amount.

From time to time, the payment processor 310 can issue a request to capture a portion of the purchase amount. The capture request can be received in the payment instrument 320 and the capture request can be issued for the payment object 330. The payment object 330, however, can resist issuing a capture request to the financial institution 340. Instead, the payment object 330 can record the request to capture a portion of the purchase amount and the payment object 330 can determine whether a portion of the purchase amount remains to be requested to be captured. This process can repeat until it is determined that the entire purchase amount has been requested for capture across multiple capture requests for portions of the purchase amount. Only at that time, the payment object 330 can request of the financial institution a capturing of the purchase amount.

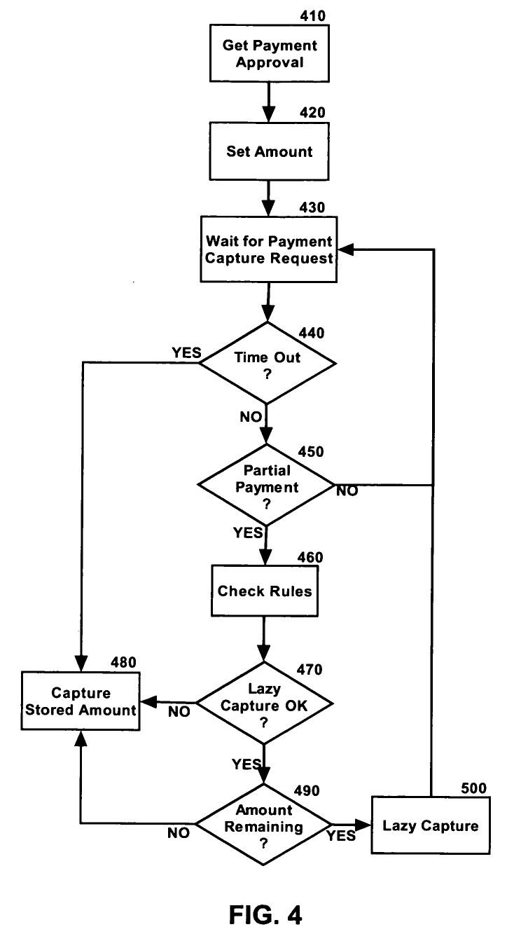

As additional illustration, FIG. 4 is a flow chart illustrating a process for scalable lazy payment capture. Beginning in block 410, payment approval can be received for a purchase amount which can be set in block 420. In block 430, the process can await the receipt of a capture request for all or a portion of the purchase amount. In decision block 440, if a period of time has elapsed during which time a number of partial capture requests have not been received so as to sum to the purchase amount, in block 480, all stored partially captured amounts can be requested for capture through a request to a merchant account system. Otherwise, the process can continue through decision block 450.

In decision block 450, if a request for partial payment is received, in block 460, a set of lazy payment capture rules can be consulted to determine whether the partial payment can be lazy captured, or whether the partial payment should be directly captured. In decision block 470, if lazy capture is permitted under the rules, in decision block 490 it can be determined whether a portion of the purchase amount has not yet been requested for capture. If so, in block 500 the portion of the purchase amount requested for capture in the partial capture request can be recorded, but not issued to the merchant account system (the “lazy payment capture”). Otherwise, in block 480 the stored amount can be captured through a request to the merchant account system.

The foregoing process can repeat in block 430 for each capture request for a portion of the purchase amount irrespective of the payment method thus providing scalability to the lazy payment process. In decision block 490, when it is determined that all portions of the purchase amount has been requested for capture, in block 480 a capture request can be issued to the merchant account system for the purchase amount. In this way, the real-time characteristic of the online commerce system can be preserved through the operation of the lazy payment capture, while excessive transaction costs can be avoided through a single capture request for the purchase amount issued to the merchant account system.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A computer implemented lazy payment capture method comprising:
receiving payment authorization for a payment amount from a merchant account system;
detecting a plurality of payment capture requests for portions of said payment amount;
consulting a set of established rules for applying lazy payment capture to said portions of said payment amount; and,
deferring a request for payment capture for said payment amount from said merchant account system until enough of said payment capture requests have been received to account for said payment amount only when permitted by said established rules.

2. The method of claim 1, wherein said detecting a plurality of payment capture requests for portions of said payment amount further comprises, for each detected payment capture request, computing a sum of portions of said payment amount for which payment capture requests have been detected, and further computing a remaining portion of said payment amount not yet requested for capture.

3. The method of claim 1, wherein said consulting a set of established rules for applying lazy payment capture to said portions of said payment amount, comprises consulting a set of established rules to determine whether said payment amount exceeds a threshold value requiring an immediate payment capture for said payment capture request, or whether said payment amount permits lazy payment capture.

4. The method of claim 1, wherein said consulting a set of established rules for applying lazy payment capture to said portions of said payment amount, comprises consulting a set of established rules to determine whether a type of ordered item requires an immediate payment capture for said payment capture request or whether said type of ordered item permits lazy payment capture.

5. The method of claim 1, wherein said consulting a set of established rules for applying lazy payment capture to said portions of said payment amount, comprises consulting a set of established rules to determine whether an identity of an associated customer requires an immediate payment capture for said payment capture request or whether said identity permits lazy payment capture.

6. The method of claim 1, wherein said consulting a set of established rules for applying lazy payment capture to said portions of said payment amount, comprises consulting a set of established rules to determine whether a proposed payment type requires an immediate payment capture for said payment capture request or whether said proposed payment type permits lazy payment capture.

7. The method of claim 2, wherein said deferring a request for payment capture for said payment amount from said merchant account system until enough of said payment capture requests have been received to account for said payment amount, comprises, deferring a request for payment capture for said payment amount from said merchant account system until said computed sum of said portions of said payment amount for which payment capture requests have been detected is equivalent to said payment amount.

8. The method of claim 2, wherein said deferring a request for payment capture for said payment amount from said merchant account system until enough of said payment capture requests have been received to account for said payment amount, comprises, deferring a request for payment capture for said payment amount from said merchant account system until said computed remaining portion of said payment amount not yet requested for capture is equal to zero.

9. The method of claim 2, wherein said deferring a request for payment capture for said payment amount from said merchant account system until enough of said payment capture requests have been received to account for said payment amount, further comprises, requesting an immediate capture of said computed sum when a threshold period of time elapses without said computed sum equaling said payment amount.

10. An online commerce system configured for lazy payment capture comprising:
an online commerce system configured for communicative coupling with a merchant account system and a plurality of customers over a data communications network; and,
scalable lazy payment capture logic coupled to said online commerce system and configured to selectively apply lazy payment capture to partial payments for authorized payment amounts for different customers using different payment methods.

11. The online commerce system of claim 10, further comprising payment authorization logic and payment capture logic coupled to said online commerce system.

12. The online commerce system of claim 10, wherein said lazy payment capture logic comprises program code enabled to defer a request for payment capture for an authorized payment amount from said merchant account system until enough of payment capture requests for portions of said authorized payment amount have been received to account for said payment amount only if permitted by a set of established lazy payment capture rules.

13. A computer program product comprising a computer usable medium having computer usable program code for lazy payment capture, said computer program product including:
computer usable program code for receiving payment authorization for a payment amount from a merchant account system;
computer usable program code for detecting a plurality of payment capture requests for portions of said payment amount;
computer usable program code for consulting a set of established rules for applying lazy payment capture to said portions of said payment amount; and,
computer usable program code for deferring a request for payment capture for said payment amount from said merchant account system until enough of said payment capture requests have been received to account for said payment amount only when permitted by said established rules.

14. The computer program product of claim 13, wherein said computer usable program code for detecting a plurality of payment capture requests for portions of said payment amount, further comprises computer usable program code for computing for each detected payment capture request a sum of portions of said payment amount for which payment capture requests have been detected, and further computing for each detected payment capture request a remaining portion of said payment amount not yet requested for capture.

15. The computer program product of claim 13, wherein said computer usable program code for consulting a set of established rules for applying lazy payment capture to said portions of said payment amount, comprises computer usable program code for consulting a set of established rules to determine whether said payment amount exceeds a threshold value requiring an immediate payment capture for said payment capture request, or whether said payment amount permits lazy payment capture.

16. The computer program product of claim 13, wherein said computer usable program code for consulting a set of established rules for applying lazy payment capture to said portions of said payment amount, comprises computer usable program code for consulting a set of established rules to determine whether a type of ordered item requires an immediate payment capture for said payment capture request or whether said type of ordered item permits lazy payment capture.

17. The computer program product of claim 13, wherein said computer usable program code for consulting a set of established rules for applying lazy payment capture to said portions of said payment amount, comprises computer usable program code for consulting a set of established rules to determine whether an identity of an associated customer requires an immediate payment capture for said payment capture request or whether said identity permits lazy payment capture.

18. The computer program product of claim 13, wherein said computer usable program code for consulting a set of established rules for applying lazy payment capture to said portions of said payment amount, comprises computer usable program code for consulting a set of established rules to determine whether a proposed payment type requires an immediate payment capture for said payment capture request or whether said proposed payment type permits lazy payment capture.

19. The computer program product of claim 14, wherein said computer usable program code for deferring a request for payment capture for said payment amount from said merchant account system until enough of said payment capture requests have been received to account for said payment amount, comprises computer usable program code for deferring a request for payment capture for said payment amount from said merchant account system until said computed sum of said portions of said payment amount for which payment capture requests have been detected is equivalent to said payment amount.

20. The computer program product of claim 14, wherein said computer usable program code for deferring a request for payment capture for said payment amount from said merchant account system until enough of said payment capture requests have been received to account for said payment amount, comprises computer usable program code for deferring a request for payment capture for said payment amount from said merchant account system until said computed remaining portion of said payment amount not yet requested for capture is equal to zero.

21. The computer program product of claim 14, wherein said computer usable program code for deferring a request for payment capture for said payment amount from said merchant account system until enough of said payment capture requests have been received to account for said payment amount, further comprises, computer usable program code for requesting an immediate capture of said computed sum when a threshold period of time elapses without said computed sum equaling said payment amount.
